(19) United States
(12) Patent Application Publication
(10) Pub. No.: US 2015/0159063 A1
(43) Pub. Date: Jun. 11, 2015

(54) ADHESIVE FOR LAMINATED SHEETS

(71) Applicant: Henkel AG & Co. KGAA, Duesseldorf (DE)

(72) Inventors: Yasushi Yamada, Osaka (JP); Noriyoshi Kamai, Hyogo (JP); Hitoshi Ikeda, Osaka (JP); Shouko Ito, Osaka (JP)

(21) Appl. No.: 14/622,951

(22) Filed: Feb. 16, 2015

Related U.S. Application Data
(63) Continuation of application No. PCT/JP2013/073072, filed on Aug. 22, 2013.

(30) Foreign Application Priority Data
Aug. 24, 2012 (JP) 2012-184804

(51) Int. Cl. C09J 175/06; C08F 220/18

(52) U.S. Cl. CPC C09J 175/06; C08F 220/18

(57) ABSTRACT

Disclosed is an adhesive for laminated sheets comprising: a urethane resin obtainable by mixing an acrylic polyol with an isocyanate compound; and a silane compound; wherein the silane compound contains a glycidyl based silane compound, wherein the acrylic polyol is obtainable by polymerizing polymerizable monomer, the polymerizable monomer contains a monomer having a hydroxyl group and the other monomer, and the other monomer contains acrylonitrile, and the isocyanate compound contains at least one selected from xylylene diisocyanate and hexamethylene diisocyanate. The adhesive for laminated sheets has a moderate curing rate and is excellent in initial adhesion to a film and in long-term hydrolysis resistance at high temperature; it is also excellent in weatherability.

### CROSS-REFERENCE TO RELATED APPLICATION

This application claims priority under Article 4 of the Paris Convention based on Japanese Patent Application No. 2012-184804 filed on Aug. 24, 2012 in Japan, the entire content of which is incorporated herein by reference.

### TECHNICAL FIELD

The present invention relates to an adhesive for laminated sheets.

### BACKGROUND ART

Outdoor materials such as wall protecting materials, roofing materials, solar battery panel materials, window materials, outdoor flooring materials, illumination protection materials, automobile members, and signboards comprise, as a constituent material, a laminate (or a laminated sheet) obtained by laminating a plurality of films with each other using an adhesive. Examples of the film composing the laminate include metal foils made of metals such as aluminum, copper and steel; metal plates and deposited metal films; and, films made of plastics such as polypropylene, polyvinyl chloride, polyester, fluororesin, and acrylic resin.

As shown in FIG. 1, a laminated sheet 10 is a laminate of a plurality of films 11 and 12, and the films 11 and 12 are laminated by interposing an adhesive 13 therebetween.

Since the laminate is exposed outdoors over a long term, excellent durability is required of an adhesive for laminated sheets. Adhesives for laminated sheets—and particularly adhesives for solar battery applications, which convert sunlight into electricity—preferably have a higher level of durability than a conventional laminated sheet adhesive.

As shown in FIG. 3, in the case of solar battery applications, the laminated sheet 10 is referred to as a back sheet and is disposed within a solar battery module 1, together with a sealing material 20, a solar battery cell 30, and a glass plate 40.

Since the solar battery module 1 is exposed outdoors over the long term, sufficient durability against sunlight is required under conditions of high temperature and high humidity. Particularly, when the adhesive 13 has poor properties, the film 11 is peeled from the film 12, and thereby the appearance of the laminated sheet 10 deteriorates. Therefore, it is required that the adhesive used in laminated sheets for the production of the solar battery module does not undergo peeling of the film even when exposed to high temperatures over a long period.

Patent Documents 1 to 3 disclose, as an example of an adhesive for laminated sheets, a urethane based adhesive for the production of a solar battery protection sheet.

Patent Document 1 discloses that a urethane adhesive which is synthesized from an acrylic polyol is suitable as an adhesive for solar battery back sheets (see Patent Document 1, claims 1 and [0048]).

Patent Document 2 discloses a protective sheet for a solar battery module in which an acrylic urethane resin is formed on a base material sheet (see Patent Document 2, claim 1, and FIGS. 1 to 3).

Patent Document 3 discloses the mixing of an isocyanate curing agent with an acrylic polyol to produce adhesives (see Patent Document 3, Table 1, Table 2); a solar battery back sheet may then be produced by using these adhesives (see Patent Document 3, [0107]).

Patent Documents 1 to 3 disclose that poor appearance of a solar battery module can be prevented by producing a solar battery back sheet using an adhesive which has both excellent hydrolysis resistance and excellent laminate strength. However, the durability requirements for adhesives used in solar battery back sheets have been increasing year by year, and it is difficult to say that the adhesives of these documents meet these high requirements of consumers.

A solar battery back sheet is commonly produced by applying an adhesive having a moderate viscosity on a film, drying the adhesive, laminating a film (dry lamination method), and aging the laminate for several days. Consequently, it is also required for the adhesive for such sheets to have excellent initial adhesion to a film in the lamination.

Since the solar battery module is used outdoors under conditions of high temperature and high humidity, plural films composing the back sheet (laminated sheet) are likely to be peeled. Particularly, it is difficult for a fluororesin based film to bond to other various base materials using the adhesive.

When exposed outdoors over a long term, the adhesive strength between the adhesive and the fluororesin based film may drastically decrease. Recently, progress has been made to improve an organic solar battery at low production cost as compared with a solar battery using silicon or an inorganic compound material. Since the organic solar battery can possess colorability or flexibility, a transparent film tends to be used as a film composing a solar battery back sheet. Therefore, it is required that the adhesive for solar battery back sheets not only maintains peel strength over a long period, but also undergoes very limited change in color difference and is excellent in weatherability.

Accordingly, it is required for the adhesive for solar battery back sheets to have higher levels of hydrolysis resistance, initial adhesion, and weatherability. When the adhesive is used for bonding fluororesin based films, there is an urgent need to suppress deterioration of adhesion of the adhesive.

Patent Document 1: JP 2011-105819 A

Patent Document 2: JP 2010-238815 A

Patent Document 3: JP 2010-263193 A

### DISCLOSURE OF THE INVENTION

### Problems to be Solved by the Invention

The present invention has been made so as to solve such a problem and an object thereof is to provide an adhesive for laminated sheets, which has a moderate curing rate, is excellent in initial adhesion to a film in the production of a laminate (laminated sheet) using a plastic film (particularly, a fluororesin based film), and is also excellent in weatherability and in long-term hydrolysis resistance at high temperature.

### Means for Solving the Problems

The present inventors have intensively studied and found, surprisingly, that it is possible to obtain an adhesive for laminated sheets, which has a moderate curing rate and is excellent in initial adhesion to a film, in long-term hydrolysis resistance at high temperature and in weatherability, when a specific polyol and a specific isocyanate compound are used as raw materials of a urethane resin and also a specific silane compound is added as a coupling agent, thus completing the present invention.

Namely, the present invention provides, in an aspect, an adhesive for laminated sheets, comprising: a urethane resin obtainable by mixing an acrylic polyol with an isocyanate compound; and, a silane compound; wherein the silane compound contains a glycidyl based silane compound, the acrylic polyol is obtainable by polymerizing a polymerizable monomer, the polymerizable monomer contains a monomer having a hydroxyl group and the other monomer, the other monomer contains acrylonitrile, and the isocyanate compound contains at least one selected from xylylene diisocyanate and hexamethylene diisocyanate.

The present invention provides, as an embodiment, an adhesive for laminated sheets, wherein an equivalent ratio (NCO/OH) of isocyanate groups derived from xylylene diisocyanate and/or hexamethylene diisocyanate to hydroxyl groups derived from the acrylic polyol is from 1.0 to 3.0.

The present invention provides, as a preferable embodiment, an adhesive for laminated sheets wherein the xylylene diisocyanate is a monomer and the hexamethylene diisocyanate is an isocyanurate form.

The present invention provides, in another aspect, a raw material comprising an acrylic polyol for producing any one of the above adhesives for laminated sheets, wherein the acrylic polyol is obtainable by polymerizing a polymerizable monomer, the polymerizable monomer contains a monomer having a hydroxyl group and the other monomer, and the other monomer contains acrylonitrile.

### Effects of the Invention

The adhesive for laminated sheets according to the present invention comprises: a urethane resin obtainable by mixing an acrylic polyol with at least one isocyanate compound selected from xylylene diisocyanate and hexamethylene diisocyanate; and, a silane compound, the silane compound containing a glycidyl based silane compound, wherein the acrylic polyol is obtainable by polymerizing a monomer having a hydroxyl group and at least one other monomer wherein the at least one other monomer contains acrylonitrile. Therefore, the adhesive has a moderate curing rate, is excellent in initial adhesion to a film and in long-term hydrolysis resistance at high temperature, and is also excellent in weatherability.

In the adhesive for laminated sheets according to the present invention, it is more preferred that an equivalence ratio (NCO/OH) of isocyanate groups derived from said isocyanate compounds—which may for instance comprise a consist of xylylene diisocyanate and/or hexamethylene diisocyanate—to hydroxyl groups derived from the acrylic polyol is from 1.0 to 3.0, since a moderate curing rate is maintained, and initial adhesion to a film, hydrolysis resistance and weatherability are improved.

In the adhesive according to the present invention, it is particularly preferred that the xylylene diisocyanate is a monomer and that the hexamethylene diisocyanate is an isocyanurate form, since a moderate curing rate is maintained, initial adhesion to a film, hydrolysis resistance and weatherability are remarkably improved, and overall performance is excellent.

In the raw material comprising an acrylic polyol for producing the adhesive for laminated sheets according to the present invention, (A) the acrylic polyol is obtainable by polymerizing polymerizable monomers; said polymerizable monomers contain a monomer having a hydroxyl group and at least one other monomer; said at least one other monomer contains acrylonitrile. Therefore, a urethane resin, which has a moderate curing rate, is excellent in initial adhesion and hydrolysis resistance, and which is also excellent in weatherability, is produced by reacting the raw material with an isocyanate compound, and thus it is possible to provide an adhesive suited for outdoor material applications, and particularly an adhesive for laminated sheets, which is useful as an adhesive for solar battery back sheets.

### BRIEF DESCRIPTION OF THE DRAWINGS

FIG. 1 is a sectional view of an embodiment of the laminated sheet.

FIG. 2 is a sectional view of a laminated sheet in accordance with another embodiment.

FIG. 3 is a sectional view of an embodiment of the outdoor material (for example, a solar battery module).

### EMBODIMENT FOR CARRYING OUT THE INVENTION

The adhesive for laminated sheets according to the present invention includes a urethane resin obtainable by mixing an acrylic polyol with an isocyanate compound, and a silane compound.

The urethane resin is a polymer obtainable by mixing and reacting the acrylic polyol with the isocyanate compound, and has a urethane bond. A hydroxyl group of the acrylic polyol reacts with an isocyanate group.

The acrylic polyol is obtainable by the addition polymerization of polymerizable monomers, said polymerizable monomers including a “monomer having a hydroxyl group” and the “other monomer”.

The “monomer having a hydroxyl group” is a radical polymerizable monomer having a hydroxyl group and an ethylenic double bond, and is not particularly limited as long as the objective adhesive of the present invention can be obtained. The monomer having a hydroxyl group includes for example, hydroxyalkyl(meth)acrylate, and the hydroxyalkyl(meth)acrylate may be used alone, or two or more hydroxyalkyl(meth)acrylates may be used in combination. The hydroxyalkyl(meth)acrylate may also be used in combination with a monomer having a hydroxyl group, other than the hydroxyalkyl(meth)acrylate.

Examples of the “hydroxyalkyl(meth)acrylate” include, but are not limited to, 2-hydroxyethyl(meth)acrylate, 2-hydroxypropyl(meth)acrylate, 3-hydroxypropyl(meth)acrylate, 4-hydroxybutyl acrylate and the like.

Examples of the “polymerizable monomer having a hydroxyl group, other than the hydroxylalkyl(meth)acrylate” include polyethylene glycol mono(meth)acrylate, polypropylene glycol mono(meth)acrylate and the like.

The “other monomer” is a “radical polymerizable monomer having an ethylenic double bond” other than the monomer having a hydroxyl group and contains acrylonitrile, and is not particularly limited as long as the objective adhesive for laminated sheets of the present invention can be obtained. The other monomer may further include a (meth)acrylic ester. The other monomer may further include a radical polymerizable monomer having an ethylenic double bond, other than acrylonitrile and (meth)acrylic ester.

The “(meth)acrylic ester” is obtainable, for example, by the condensation reaction of (meth)acrylic acid with a monoalcohol, and has an ester bond. Even though it has an ester bond, a monomer having a hydroxyl group is not included in the (meth)acrylic ester. Specific examples thereof include (meth)acrylic acid alkyl esters such as methyl(meth)acrylate, ethyl(meth)acrylate, butyl(meth)acrylate, 2-ethylhexyl(meth)acrylate, cyclohexyl(meth)acrylate, dicyclopentanyl(meth)acrylate, and isobornyl(meth)acrylate; glycidyl(meth)acrylate and the like. Both linear alkyl groups and cyclic alkyl groups are included in this “alkyl group”.

In the present invention, it is preferred to include at least one monomer selected from methyl(meth)acrylate, ethyl(meth)acrylate, butyl(meth)acrylate, 2-ethylhexyl(meth)acrylate, and cyclohexyl(meth)acrylate; it is more preferred to include at least one monomer selected from methyl(meth)acrylate, ethyl(meth)acrylate, and butyl(meth)acrylate.

Examples of the “radical polymerizable monomers having an ethylenic double bond, other than acrylonitrile and (meth)acrylic ester” include, but are not limited to, (meth)acrylic acid, styrene, vinyltoluene and the like.

The “acrylonitrile” is a compound represented by the chemical formula: CH₂═CH—CN, and is also called acrylic nitrile, acrylic acid nitrile, or vinyl cyanide.

The content of acrylonitrile is preferably from 1 to 40 parts by weight, more preferably from 5 to 35 parts by weight, and particularly preferably from 5 to 25 parts by weight, based on 100 parts by weight of polymerizable monomers.

When the content of the acrylonitrile is within the above range, it is possible to obtain an adhesive for solar battery back sheets, which provides an excellent balance amongst coatability, initial adhesion to a film, and adhesion (hydrolysis resistance) at high temperature.

In the present description, acrylic acid and methacrylic acid are collectively referred to as “(meth)acrylic acid”, and “acrylic ester and methacrylic ester” are collectively referred to as “(meth)acrylic ester” or “(meth)acrylate”.

As long as the objective adhesive of the present invention can be obtained, there is no particular limitation on the polymerization method of the polymerizable monomer. For example, the above-mentioned polymerizable monomers can be radically polymerized by a conventional solution polymerization method in an organic solvent using an appropriate catalyst. Herein, the “organic solvent” can be used so as to polymerize the polymerizable monomer and there is no particular limitation thereof as long as it does not substantially exert an adverse influence on characteristics of the adhesive after the polymerization reaction. Examples of such solvent include: aromatic solvents such as toluene and xylene; ester based solvents such as ethyl acetate and butyl acetate; and, combinations thereof.

The polymerization reaction conditions such as reaction temperature, reaction time, type of organic solvents, type and concentration of monomers, stirring rate, as well as type and concentration of polymerization initiators in the polymerization of the polymerizable monomers, can be appropriately selected according to objective characteristics of the adhesive.

The “polymerization initiator” is preferably a compound which can accelerate the polymerization of the polymerizable monomer through its addition in a small amount and can be used in an organic solvent. Examples of the polymerization initiator include ammonium persulfate, t-butyl peroxybenzoate, 2,2-azobisisobutyronitrile (AIBN), and 2,2-azobis(2,4-dimethylvarelonitrile).

A chain transfer agent can be appropriately used for the polymerization in the present invention so as to adjust the molecular weight. It is possible to use, as the “chain transfer agent”, compounds well-known to those skilled in the art. Examples thereof include mercaptans such as n-dodecylmercaptan (nDM), laurylmethylmercaptan, and mercaptoethanol.

As mentioned above, the acrylic polyol is obtainable by polymerizing the polymerizable monomers. From the viewpoint of coatability of the adhesive, the weight average molecular weight (M_{W}) of the acrylic polyol is preferably 200,000 or less, and more preferably from 5,000 to 100,000. The weight average molecular weight (M_{W}) is a value measured by gel permeation chromatography (GPC) and converted in terms of polystyrene standard. Specifically, the value can be measured by using the following GPC apparatus and measuring method. HCL-8220GPC manufactured by TOSOH CORPORATION is used as a GPC apparatus, and RI is used as a detector. Two TSKgel SuperMultipore HZ-M manufactured by TOSOH CORPORATION are used as a GPC column. A sample is dissolved in tetrahydrofuran and the obtained solution is allowed to flow at a flow rate of 0.35 ml/minute and at a column temperature of 40° C., and a measured Mw was obtained. The objective Mw is determined by conversion of the measured molecular weight based on a calibration curve which is obtained by using polystyrene having a monodisperse molecular weight as a standard reference material.

A glass transition temperature (T_{g}) of the acrylic polyol can be set by adjusting the kind and the mass fractions of monomers to be used. The glass transition temperature (T_{g}) of the acrylic polyol can be determined based on a glass transition temperature of a homopolymer obtainable from each monomer and a mass fraction of the homopolymer used in the acrylic polyol using the following calculation formula (i). It is preferred to determine a composition of the monomer using the glass transition temperature determined by the calculation:

1/Tg=W1/Tg1+W2/Tg2+ . . . +Wn/Tgn (i):

where Tg in the above formula (i) denotes the glass transition temperature of the acrylic polyol, each of W1, W2, . . . , Wn denotes a mass fraction of each monomer, and each of Tg1, Tg2, . . . , and Tgn denotes a glass transition temperature of a homopolymer of each corresponding monomer.

A value disclosed in a reference document can be used as a Tg of the homopolymer. It may be useful, for example, to refer to the following reference documents: Acrylic Ester Catalog of Mitsubishi Rayon Co., Ltd. (1997 Version), edited by Kyozo Kitaoka; “Shin Kobunshi Bunko 7, Guide to Synthetic Resin for Coating Material”, Kobunshi Kankokai, published in 1997, pp. 168-169; and “POLYMER HANDBOOK”, 3rd Edition, pp. 209-277, John Wiley & Sons, Inc. published in 1989.

In the present specification, the glass transition temperatures of homopolymers of the following monomers are as follows.

Methyl methacrylate: 105° C.

n-Butyl acrylate: −54° C.

Ethyl acrylate: −20° C.

2-Hydroxyethyl methacrylate: 55° C.

2-Hydroxyethyl acrylate: −15° C.

Glycidyl methacrylate: 41° C.

Acrylonitrile: 130° C.

Styrene: 105° C.

In the present invention, the glass transition temperature of the acrylic polyol is preferably from −20° C. to 20° C., more preferably −15° C. to 20° C., and particularly preferably −10° C. to 15° C., from the viewpoint of the initial adhesion to a film. When the glass transition temperature of the acrylic polyol is within the above range, the adhesive of the present invention is less likely to decrease in cohesive force, is more excellent in initial adhesion, and also can better maintain hydrolysis resistance.

The hydroxyl value of the acrylic polyol is preferably from 0.5 to 45 mgKOH/g, more preferably from 1 to 40 mgKOH/g, and particularly preferably from 3 to 30 mgKOH/g. When the hydroxyl value of the acrylic polyol is within the above range, it is possible to obtain an adhesive which is excellent in initial adhesion, adhesion at high temperature, and hydrolysis resistance. Particularly, when a solar battery back sheet is produced by laminating a plurality of films using the adhesive of the present invention, the film becomes much less likely to peel from the adhesive.

In the present description, the hydroxyl value is a number of mg of potassium hydroxide required to neutralize acetic acid bonded with hydroxyl groups when 1 g of a resin is acetylated.

In the present invention, the hydroxyl value is specifically calculated by the following formula (ii).

Hydroxyl value=[(weight of (meth)acrylate having a hydroxyl group)/(molecular weight of (meth)acrylate having a hydroxyl group)]×(mole number of hydroxyl groups contained in 1f mol of (meth)acrylate monomer having a hydroxyl group)×[(formula weight of KOH×1,000)/(weight of the acrylic polyol)] (ii):

There is no particular limitation on the isocyanate compound according to the present invention as long as the objective adhesive of the present invention can be obtained and the isocyanate compound contains at least one selected from xylylene diisocyanate and hexamethylene diisocyanate. The isocyanate compound may contain the other isocyanate compound. The isocyanate compound is preferably at least one selected from a trimethylolpropane adduct, an isocyanurate form, a biuret form, an allophanate form, and an isocyanate monomer.

When the isocyanate compound contains these compounds, the adhesive for laminated sheets can be used more preferably over a long term at high temperature and high humidity since the hydrolysis resistance is remarkably improved.

The isocyanate compound is mainly classified into an “isocyanate having no aromatic ring” and an “isocyanate having an aromatic ring”.

Examples of the isocyanate having no aromatic ring include an “aliphatic isocyanate” and an “alicyclic isocyanate”.

The aliphatic isocyanate refers to a compound which has a chain-like hydrocarbon chain in which isocyanate groups are directly bound to the hydrocarbon chain, and also has no cyclic hydrocarbon chain.

The alicyclic isocyanate is a compound which has a cyclic hydrocarbon chain and may have a chain-like hydrocarbon chain. The isocyanate group may be either directly bound to the cyclic hydrocarbon chain, or may be directly bound to the chain-like hydrocarbon chain which may be present.

Examples of the aliphatic isocyanate include 1,4-diisocyanatobutane, 1,5-diisocyanatopentane, hexamethylene diisocyanate (HDI), 1,6-diisocyanato-2,2,4-trimethylhexane, methyl 2,6-diisocyanatohexanoate (lysine diisocyanate) and the like.

Examples of the alicyclic isocyanate include 5-isocyanato-1-isocyanatomethyl-1,3,3-trimethylcyclohexane (isophorone diisocyanate), 1,3-bis(isocyanatomethyl)cyclohexane (hydrogenated xylylene diisocyanate), bis(4-isocyanatocyclohexyl)methane (hydrogenated diphenylmethane diisocyanate), 1,4-diisocyanatocyclohexane and the like.

It is sufficient for the isocyanate having an aromatic ring (hereinafter referred to as an aromatic isocyanate) to have an aromatic ring, and it is not necessary that the isocyanate groups are directly bonded to the aromatic ring. The aromatic ring may be an aromatic ring in which two or more benzene rings are fused.

Examples of the aromatic isocyanate include 4,4′-diphenylmethane diisocyanate (MDI), p-phenylene diisocyanate, m-phenylene diisocyanate, tolylene diisocyanate (TDI), xylylene diisocyanate (XDI) and the like. These isocyanate compounds can be used alone or in combination.

Since xylylene diisocyanate (OCN—CH₂—C₆H₄—CH₂—NCO) has an aromatic ring, it corresponds to the aromatic isocyanate even though the isocyanate groups are not directly bound to the aromatic ring.

In the present invention, the isocyanate compound contains at least one selected from hexamethylene diisocyanate (HDI) as the aliphatic isocyanate and xylylene diisocyanate (XDI) as the aromatic isocyanate, from the viewpoint of improving initial adhesion to a film after aging, curing time, and hydrolysis resistance. It is more preferred to contain both XDI and HDI.

HDI is more preferably an isocyanurate form, and XDI is more preferably a monomer.

In the present invention, the isocyanate compound may further contain at least one selected from isophorone diisocyanate as the alicyclic isocyanate, and 4,4′-diphenylmethane diisocyanate (MDI) and tolylene diisocyanate (TDI) as the aromatic isocyanates, from the viewpoint of improving initial adhesion to a film after aging, curing time, and hydrolysis resistance.

The urethane resin according to the present invention is obtainable by reacting the acrylic polyol with the isocyanate compound. In the reaction, a known method can be used and the reaction can usually be performed by mixing the acrylic polyol with the isocyanate compound. There is no particular limitation on the mixing method as long as the urethane resin according to the present invention can be obtained.

In the present invention, an equivalence ratio (NCO/OH) of isocyanate groups derived from xylylene diisocyanate and/or hexamethylene diisocyanate to hydroxyl groups derived from the acrylic polyol is preferably from 1.0 to 3.0, more preferably from 1.0 to 2.5, and particularly preferably from 1.5 to 2.5. When the equivalence ratio (NCO/OH) is from 1.0 to 3.0, moderate curing rate is maintained preferably, and initial adhesion to a film, hydrolysis resistance and weatherability are improved.

The adhesive for laminated sheets of the present invention contains a silane compound. The silane compound includes a glycidyl based silane compound which is a kind of epoxy based silane compounds.

The glycidyl based silane compound is a silane compound having a glycidoxy group represented by the following formula (1):

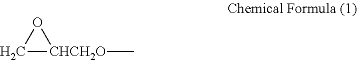

The “glycidyl based silane compound” refers to a compound having a glycidoxy group, and specific examples thereof include 3-glycidoxypropylmethyldiisopropoxysilane, 3-glycidoxypropyltrimethoxysilane, 3-glycidoxypropyltriethoxysilane, 3-glycidoxypropyldiethoxysilane and the like.

These glycidyl based silane compounds can be used alone or in combination.

In the adhesive for laminated sheets according to the present invention, the glycidyl based silane compound is particularly preferably 3-glycidoxypropyltrialkoxysilane.

Examples of a 3-glycidoxypropyltrialkoxysilane compound include 3-glycidoxypropyltrimethoxysilane and 3-glycidoxypropyltriethoxysilane.

For the 3-glycidoxypropyltrialkoxysilane compound, 3-glycidoxypropyltriethoxysilane is most suited as an embodiment of the present invention.

The glycidyl based silane compound preferably acts as a silane coupling agent. The silane coupling agent refers to a compound which is composed of an organic substance and silicon, and which compound also has both an organic functional group “Y” such as an amino group, an epoxy group, a methacrylic group, a vinyl group, or a mercapto group, which group is expected to react or interact with an organic substance, and a hydrolyzable group “OR” such as a methoxy group, an ethoxy group, or a methylcarbonyloxy group in one molecule, and which compound can combine an organic material and an inorganic material, while the organic material and the inorganic material are usually much less likely to be combined to each other.

Therefore, the compound, which is a glycidyl based silane compound and which acts as a silane coupling agent, means a silane coupling agent containing a functional group having a glycidoxy group as the organic functional group “Y”. When the adhesive for laminated sheets of the present invention contains the glycidoxy based silane compound, initial adhesion and hydrolysis resistance are improved, and the initial adhesion between polyvinylidene fluoride (PVDF) and polyethylene terephthalate (PET) is excellent.

There is no limitation on the method of mixing a glycidyl based silane compound, as long as the objective adhesive can be obtained. For example, the glycidyl based silane compound may be mixed in advance with the acrylic polyol, or may be post-added to the urethane resin obtainable by mixing the acrylic polyol with the isocyanate compound. The glycidoxy based silane compound may be contained in the adhesive for laminated sheets in a state of being combined with the urethane resin after reacting with the isocyanate compound, or may be contained in the adhesive for laminated sheets in an unreacted state.

The glycidyl based silane compound may be used in combination with the other silane compound.

It is possible to use, as “the other silane compound”, for example, an epoxycyclohexyl based silane compound, a (meth)acryloxyalkyltrialkoxysilane compound, a (meth)acryloxyalkylalkylalkoxysilane compound, a vinyltrialkoxysilane compound, a vinylalkylalkoxysilane compound, a mercaptosilane compound, and an isocyanuratesilane compound. However, the other silane compound is not limited only to these silane compounds.

The “epoxycyclohexyl based silane compound” is a kind of epoxy based silane compound and is a compound having a 3,4-epoxycyclohexyl group represented by the following formula (2):

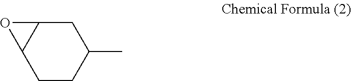

Specific examples of the “epoxycyclohexyl based silane compound” include 2-(3,4-epoxycyclohexyl)ethyltrimethoxysilane, 2-(3,4-epoxycyclohexyl)ethyltriethoxysilane and the like. Examples of the “(meth)acryloxyalkyltrialkoxysilane compound” include 3-(meth)acryloxypropyltrimethoxysilane, 3-(meth)acryloxypropyltriethoxysilane, 2-(meth)acryloxyethyltrimethoxysilane and the like.

Examples of the “(meth)acryloxyalkylalkylalkoxysilane compound” include 3-(meth)acryloxypropylmethyldimethoxysilane, 3-(meth)acryloxypropylmethyldiethoxysilane, 3-(meth)acryloxypropylethyldiethoxysilane, 2-(meth)acryloxyethylmethyldimethoxysilane and the like.

Examples of the “vinyltrialkoxysilane compound” include vinyltrimethoxysilane, vinyltriethoxysilane, vinyldimethoxyethoxysilane, vinyltri(methoxyethoxy)silane, vinyltri(ethoxymethoxy)silane and the like.

Examples of the “vinylalkylalkoxysilane compound” include vinylmethyldimethoxysilane, vinylethyldi(methoxyethoxy)silane, vinyldimethylmethoxysilane, vinyldiethyl(methoxyethoxy)silane and the like.

Examples of the “mercaptosilane compound” include 3-mercaptopropyltrimethoxysilane, 3-mercaptopropyltriethoxysilane and the like.

Examples of the “isocyanuratesilane compound” include tris(3-(trimethoxysilyl)propyl)isocyanurate and the like.

The adhesive for laminated sheets of the present invention may contain an ultraviolet absorber for the purpose of improving long-term weatherability. It is possible to use, as the ultraviolet absorber, a hydroxyphenyltriazine based compound and other commercially available ultraviolet absorbers. The “hydroxyphenyltriazine based compound” is one type of a triazine derivative in which a hydroxyphenyl derivative is combined with a carbon atom of the triazine derivative, and examples thereof include TINUVIN 400, TINUVIN 405, TINUVIN 479, TINUVIN 477 and TINUVIN 460 (all of which are trade names) which are available from BASF Corporation.

The adhesive for laminated sheets may further contain a hindered phenol based compound, on which there is no particular limitation as long as the objective adhesive according to the present invention can be obtained.

Commercially available products can be used as the hindered phenol based compound such as those available from BASF Corporation. Examples thereof include IRGANOX1010, IRGANOX1035, IRGANOX1076, IRGANOX1135, IRGANOX1330 and IRGANOX1520 (all of which are trade names). The hindered phenol based compound is added to the adhesive as an antioxidant and may be used, for example, in combination with a phosphite based antioxidant, a thioether based antioxidant, an amine based antioxidant and the like.

The adhesive according to the present invention may further contain a hindered amine based compound on which there is no particular limitation as long as the objective adhesive according to the present invention can be obtained.

Commercially available products can be used as the hindered amine based compound. Examples of the hindered amine based compound include TINUVIN 765, TINUVIN 111FDL, TINUVIN 123, TINUVIN 144, TINUVIN 152, TINUVIN 292 and TINUVIN 5100 (all of which are trade names) which are commercially available from BASF Corporation. The hindered amine based compound is added to the adhesive as a light stabilizer and may be used, for example, in combination with a benzotriazole based compound, a benzoate based compound and the like.

The adhesive for laminated sheets according to the present invention can further contain one or more other components as long as the objective adhesive can be obtained.

There is no particular limitation on the timing of the addition of the “other components” to the adhesive as long as the objective adhesive can be obtained. For example, the other components may be added together with the acrylic polyol and the isocyanate compound in the synthesis of the urethane resin, or may be added after synthesizing the urethane resin by reacting the acrylic polyol with the isocyanate compound.

Examples of the “other component” include a tackifier resin, a pigment, a plasticizer, a flame retardant, a wax and the like.

Examples of the “tackifier resin” include styrene based resin, terpene based resin, aliphatic petroleum resin, aromatic petroleum resin, rosin ester, acrylic resin, polyester resin (excluding polyesterpolyol) and the like.

Examples of the “pigment” include titanium oxide, carbon black and the like.

Examples of the “plasticizer” include dioctyl phthalate, dibutyl phthalate, diisononyl adipate, dioctyl adipate, mineral spirit and the like.

Examples of the “flame retardant” include a halogen based flame retardants, phosphorous based flame retardants, antimony based flame retardants, metal hydroxide based flame retardants and the like.

The “wax” is preferably a wax such as paraffin wax and microcrystalline wax.

Viscosity of the adhesive for laminated sheets according to the present invention is measured by using a rotational viscometer (Model BM, manufactured by TOKIMEC Inc.).

When solution viscosity at a solids content of 40% is 4,000 mPa·s or more, the coatability of the adhesive can deteriorate. If a solvent is further added so as to decrease the viscosity, coating is performed at low solid component concentration, and thus productivity of the adhesive may deteriorate.

The adhesive for laminated sheets of the present invention can be produced by mixing the above-mentioned urethane resin and silane compound, and a plasticizer, a photostabilizer and/or other components which can be optionally added. There is no particular limitation on the mixing method or on the order of mixing the components; the adhesive can be produced without requiring a special mixing method and a special mixing order. The obtained adhesive can maintain excellent hydrolysis resistance at high temperature over a long term, and is also excellent in initial adhesion to a film.

Therefore, a laminated sheet is produced by laminating a plurality of adherends using the adhesive for laminated sheets of the present invention, and the obtained laminated sheet is used for the production of various outdoor materials.

Examples of such outdoor materials include wall protecting materials, roofing materials, solar battery modules, window materials, outdoor flooring materials, illumination protection materials, automobile members, and signboards. These outdoor materials include a laminated sheet as an adherend, which is obtained by laminating a plurality of films with each other. Examples of the film include a film obtained by depositing metal on a plastic film (metal deposited film) and a film with no metal deposited thereon (plastic film).

It is required for an adhesive for producing solar battery modules, as a category of adhesives for laminated sheets, to have a particularly high curing rate and level of adhesion to a film after aging, and further to have long-term hydrolysis resistance at high temperature. The adhesive for laminated sheets of the present invention is excellent in long-term hydrolysis resistance at high temperature, and is thus suitable as an adhesive for solar battery back sheets.

In the case of producing a solar battery back sheet, the adhesive of the present invention is applied to a film. The application can be performed by various methods such as gravure coating, wire bar coating, air knife coating, die coating, lip coating and comma coating methods. Plural films coated with the adhesive are laminated with each other to complete the solar battery back sheet.

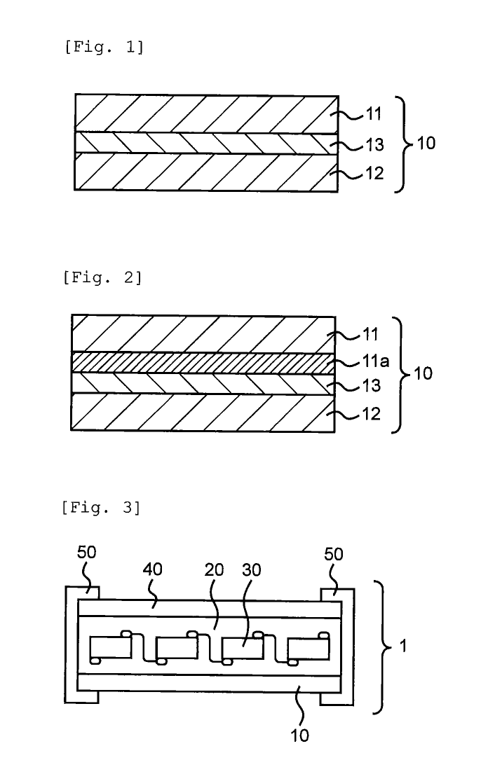

An embodiment of the solar battery back sheet of the present invention is shown in each of FIGS. 1 to 3, but the present invention is not limited to these embodiments.

FIG. 1 is a sectional view of a solar battery back sheet as an embodiment of the laminated sheets of the present invention. The solar battery back sheet 10 is formed of two films and an adhesive for laminated sheets 13 interposed therebetween, and the two films 11 and 12 are laminated with each other using the adhesive for laminated sheets 13. The films 11 and 12 may be made of either the same or different material. In FIG. 1, the two films 11 and 12 are laminated with each other, or three or more films may be laminated with one another.

Another embodiment of the laminated sheet (solar battery back sheet) according to the present invention is shown in FIG. 2. In FIG. 2, a thin film (or a foil film) 11a is formed between the film 11 and the outdoor urethane adhesive 13. For example, FIG. 2 shows an embodiment in which a metal thin film 11a is formed on the surface of the film 11 when the film 11 is a plastic film. The metal thin film 11a can be formed on the surface of the plastic film 11 by vapor deposition, and the solar battery back sheet of FIG. 2 can be obtained by laminating the metal thin film 11, on which surface the metal thin film 11a is formed, with the film 12 by interposing the adhesive for laminated sheets 13 therebetween.

Examples of the metal to be deposited on the plastic film include aluminum, steel, copper and the like. It is possible to impart barrier properties to the plastic film by subjecting the film to vapor deposition. Silicon oxide or aluminum oxide is used as a vapor deposition material. The plastic film 11 used as a base material may be either transparent, or white- or black-colored.

A plastic film made of polyvinyl chloride, polyester, fluororesin or an acrylic resin is used as the film 12. In order to impart heat resistance, weatherability, rigidity, insulating properties and the like, a polyethylene terephthalate film or a polybutylene terephthalate film is preferably used. The films 11 and 12 may be transparent and/or may be colored.

The deposited thin film 11a of the film 11 and the film 12 are laminated with each other using the adhesive 13 according to the present invention; the films 11 and 12 are often laminated with each other by a dry lamination method.

FIG. 3 shows a sectional view of an example of a solar battery module as an embodiment of the outdoor material of the present invention. In FIG. 3, it is possible to obtain a solar battery module 1 by the laying over one another of a glass plate 40, a sealing material 20 such as an ethylene-vinyl acetate resin (EVA), plural solar battery cells 30 which are commonly connected to each other so as to generate a desired voltage, and a back sheet 10; these members 10, 20, 30 and 40 are then fixed using a spacer 50.

As mentioned above, since the back sheet 10 is a laminate of the plurality of the films 11 and 12, it is required for the urethane adhesive 13 to cause no peeling of the films 11 and 12 even though the back sheet 10 is exposed outdoors over a long term.

The solar battery cell 30 is often produced using silicon, and is sometimes produced using an organic resin containing a dye. In that case, the solar battery module 1 becomes an organic (dye sensitized) solar battery module. Since colorability is required for the organic (dye sensitized) solar battery, a transparent film is often used as the film 11 and the film 12 which compose the solar battery back sheet 10. Therefore, it is required for the adhesive for said solar battery back sheets 13 to cause very small change in color difference even though exposed outdoors over a long term, and to have excellent weatherability.

Main embodiments of the present invention will be given below.

An adhesive for laminated sheets, comprising:

a urethane resin obtainable by mixing an acrylic polyol with an isocyanate compound; and

a silane compound; wherein

the silane compound contains a glycidyl based silane compound, the acrylic polyol is obtainable by polymerizing polymerizable monomer, the polymerizable monomer contains a monomer having a hydroxyl group and the other monomer, the other monomer contains acrylonitrile, and the isocyanate compound contains at least one selected from xylylene diisocyanate and hexamethylene diisocyanate.

The adhesive for laminated sheets according to the above 1, wherein the equivalence ratio (NCO/OH) of isocyanate groups from said isocyanate compound(s) to hydroxyl groups derived from the acrylic polyol (A) is from 1.0 to 3.0.

The adhesive for laminated sheets according to the above 1 or 2, wherein the xylylene diisocyanate is a monomer and the hexamethylene diisocyanate is an isocyanurate form.

A raw material comprising an acrylic polyol for producing the adhesive for laminated sheets according to any one of the above 1 to 3, wherein the acrylic polyol is obtainable by polymerizing polymerizable monomers, the polymerizable monomers contain a monomer having a hydroxyl group and at least one other monomer, wherein said at least one other monomer contains acrylonitrile.

### EXAMPLES

The present invention will be described below by way of Examples and Comparative Examples; these Examples are merely for illustrative purposes and are not meant to be limiting on the present invention.

### Synthesis of Acrylic Polyol

### Synthetic Example (A1) (Acrylic Polyol)

In a four-necked flask equipped with a stirring blade, a thermometer and a reflux condenser, 100 g of ethyl acetate (manufactured by Wako Pure Chemical Industries, Ltd.) was charged and refluxed at about 80° C. In the flask, 1 g of 2,2-azobisisobutyronitrile as a polymerization initiator was added and a mixture of monomers in each amount shown in Table 1 was continuously added dropwise over 1 hour and 30 minutes. After heating for 2 hours, a solution of an acrylic polyol (A1) having a non-volatile content (solid content) of 50.0% by weight was obtained.

The composition of the polymerizable monomer used to synthesize the acrylic polyol (A1), and physical properties of the obtained acrylic polymol A1 are shown in Table 1.

### Synthetic Examples 2 to 8

In the same manner as in Synthetic Example 1, except that the composition of monomers used to synthesize the acrylic polyol (A1) in Synthetic Example 1 was changed as shown in Table 1, acrylic polyols (A2) to (A′7), and an acrylic polymer (A′8) (having no hydroxyl group) were obtained. Physical properties of the obtained acrylic polyols and acrylic polymer are shown in Table 1.

The polymerizable monomers and other components in Table 1 are shown below.
Methyl methacrylate (MMA): manufactured by Wako Pure Chemical Industries, Ltd.
Butyl acrylate (BA): the same as above
Ethyl acrylate (EA): the same as above
Glycidyl methacrylate (GMA): the same as above
Acrylonitrile (AN): the same as above
2-Hydroxyethyl methacrylate (HEMA): the same as above
2-Hydroxyethyl acrylate (HEA): the same as above
Styrene (St): the same as above
2,2-Azobisisobutyronitrile (AIBN): manufactured by Otsuka Chemical Co., Ltd.

TABLE 1

| | Synthetic Examples | | | | | | | |
|---|---|---|---|---|---|---|---|---|
| | 1 | 2 | 3 | 4 | 5 | 6 | 7 | 8 |
| St | 2 | 3 | 2 | 0 | 0 | 0 | 0 | 3 |
| MMA | 19 | 22 | 44 | 39 | 39 | 39 | 44 | 22 |
| BA | 67 | 56 | 42 | 45 | 41 | 50 | 54 | 58 |
| EA | 0 | 0 | 0 | 0 | 0 | 0 | 0 | 0 |
| GMA | 0 | 2 | 0 | 0 | 0 | 0 | 0 | 2 |
| AN | 10 | 15 | 10 | 10 | 10 | 10 | 0 | 15 |
| HEMA | 2 | 2 | 0 | 6 | 10 | 1 | 2 | 0 |
| HEA | 0 | 0 | 2 | 0 | 0 | 0 | 0 | 0 |
| AIBN | 1 | 1 | 1 | 1 | 1 | 1 | 1 | 1 |
| Tg (° C.) of | −18 | −4 | 16 | 11 | 16 | 5 | −9 | −6 |
| acrylic polyol | | | | | | | | |
| Hydroxyl value | 8.6 | 8.6 | 9.7 | 25.9 | 43.1 | 4.3 | 8.6 | 0 |
| (mgKOH/g) | | | | | | | | |
| Weight average | 40000 | 41000 | 36000 | 35000 | 40000 | 42000 | 43000 | 40000 |
| molecular weight | | | | | | | | |
| Polymer | A1 | A2 | A3 | A4 | A5 | A6 | A′7 | A′8 |

Unit of value indicating the composition of the polymerizable monomer is parts by weight.

### Calculation of Glass Transition Temperature (Tg) of Acrylic Polyol and Acrylic Polymer

Tgs of the acrylic polyols and acrylic polymer (A1) to (A′8) were calculated by the above-mentioned formula (i) using the glass transition temperatures of homopolymers of the “polymerizable monomers” as the raw materials of the respective polyols and polymer.

Document values were used as the Tgs of homopolymers of methyl methacrylate and so on.

### Production of Adhesive for Laminated Sheets

Raw materials of adhesives for laminated sheets used in Examples and Comparative Examples are shown below.

### (A) Acrylic Polyol

The acrylic polyols correspond to the acrylic polyols (A1) to (A6) shown in Table 1.

### (A′) Acrylic Polyol′

The acrylic polyol′ corresponds to the acrylic polyol (A′7) in Table 1.

The acrylic polymer (having no hydroxyl group) corresponds to the acrylic polymer (A′8) in Table 1.

### (B) Silane Compound

(B1) 3-Glycidoxypropyltrimethoxysilane (KBM-403 (trade name) manufactured by Shin-Etsu Chemical Co., Ltd.)
(B2) 3-Glycidoxypropyltriethoxysilane (Z-6041 (trade name) manufactured by Dow Corning Toray Co., Ltd.)
(B3) 3-Glycidoxypropylmethyldimethoxysilane (Z-6044 (trade name) manufactured by Dow Corning Toray Co., Ltd.)
(B′4) 2-(3,4-Epoxycyclohexyl)ethyltrimethoxysilane (KBM-303 (trade name) manufactured by Shin-Etsu Chemical Co., Ltd.)
(B′5) Vinyltriacetoxysilane (Z-6075 (trade name) manufactured by Dow Corning Toray Co., Ltd.)
(B′6) 3-Methacryloxypropyltrimethoxysilane (SZ-6030 (trade name) manufactured by Dow Corning Toray Co., Ltd.)

### (C) Isocyanate Compound

(C1) <Aliphatic> Isocyanurate of hexamethylene diisocyanate (HDI) (Sumidur N3300 (trade name) manufactured by Sumitomo Bayer Urethane Co., Ltd., NCO content=21.8% by weight)
(C2) <Aromatic> Xylylene diisocyanate (XDI) monomer (Takenate 500 (trade name) manufactured by Mitsui Chemicals, Incorporated., NCO content=44.7% by weight)
(C3) <Aromatic> Adduct form of xylylene diisocyanate (XDI) (Takenate D-110N (trade name) manufactured by Mitsui Chemicals, Incorporated., NCO content=15.3% by weight)
(C′4) <Aromatic> 4,4′-diphenylmethane diisocyanate (MDI) (MILLIONATE MT (trade name) manufactured by Nippon Polyurethane Industry Co., Ltd., NCO content=33.6% by weight)
(C′5) <Aromatic> TMP adduct form of tolylene diisocyanate (TDI) (Desmodur L75 (trade name) manufactured by Sumitomo Bayer Urethane Co., Ltd., NCO content=18.0% by weight)

A urethane resin is obtained by reacting the acrylic polyol with the isocyanate compound.

The below-mentioned adhesives for laminated sheets of Examples 1 to 18 and Comparative Examples 1 to 8 were produced by mixing the above-mentioned components. Detailed compositions of the adhesives are shown in Tables 2 to 4. The production processes thereof were performed in accordance with the steps of Example 1. The obtained adhesives were evaluated by the following tests.

### Example 1

### Production of Adhesive for Solar Battery Back Sheets

As shown in Table 2, 93.1 g of the acrylic polyol (A1) [186.2 g of an ethyl acetate solution of the acrylic polyol (A1) (solid content: 50.0% by weight)] was mixed with 2.8 g [3.0% based on 100% of the solid content of the acrylic polyol (A1)] of the glycidyl based silane compound (B1), and then 2.8 g of the isocyanate compound (C1) and 1.3 g of the isocyanate compound (C2) were added, followed by mixing. Furthermore, ethyl acetate was added to the mixture to prepare an adhesive solution having a solid content of 30% by weight. Using this solution thus prepared as an adhesive, the following tests were carried out.

### Production of Adhesive-Coated PET Sheet and Laminate 1

First, the adhesive of Example 1 was applied to a transparent polyethylene terephthalate (PET) sheet (O300EW36 (trade name) manufactured by Mitsubishi Polyester Film Corporation) so that the weight of the solid component becomes 10 g/m², and then dried at 80° C. for 10 minutes to obtain an adhesive-coated PET sheet.

Then, a 50 μm thick surface-treated transparent polyolefin film (Linear Low Density film LL-XUMN#30 (trade name) manufactured by FUTAMURA CHEMICAL CO., LTD.) was laid on the adhesive-coated surface of the adhesive-coated PET sheet so that the surface-treated surface was brought into contact with the adhesive-coated surface, and then both films were pressed using a planar press machine (ASF-5 (trade name) manufactured by SHINTO Metal Industries Corporation) under a pressing pressure (or closing pressure) of 1.0 MPa at 50° C. for 30 minutes. Both films were aged at 50° C. for 7 days to obtain a laminate 1 composed of polyolefin film/adhesive/PET sheet.

### Production of Laminate 2

A 30 μm thick surface-treated white polyvinylidene fluoride film (Kynar film (trade name) manufactured by Arkema Inc.) was laid on the adhesive-coated surface of the adhesive-coated PET sheet so that the surface-treated surface was brought into contact with the adhesive-coated surface, and then both films were pressed using a planar press machine (ASF-5 (trade name) manufactured by SHINTO Metal Industries Corporation) under a pressing pressure (or closing pressure) of 1.0 MPa at 50° C. for 30 minutes. Both films were aged at 50° C. for 7 days to obtain a film laminate 2 composed of polyvinylidene fluoride film (PVDF)/adhesive/PET sheet.

### Production of Film for Evaluation of Weatherability

The adhesive of Example 1 was applied on a slide glass (3 mm×50 mm×150 mm) so that the weight of the solid component becomes 10 g/m², followed by aging at 50° C. for 7 days to obtain a film for evaluation of weatherability.

### Evaluation

The adhesives were evaluated by the following methods. The evaluation results are shown in Tables 2 to 4.

1. Evaluation of Curing Rate (Appearance after Pressure Cooker Test (PCT))

With respect to a laminate 1 aged at 50° C. for 3 days, the curing rate was evaluated by an accelerated evaluation method using pressurized steam.

The laminate 1 was cut into pieces of AS size and then evaluation was performed using a high pressure cooker (Autoclave SP300 (trade name) manufactured by Yamato Scientific Co., Ltd.). After a wet heat state was continued at 121° C. under 1.4 MPa for 100 hours, lifting and peeling of the polyethylene film were visually observed. The evaluation criteria were as shown below.

A: Neither lifting nor peeling of the film occurred.

C: Lifting and peeling of the film occurred.

### 2. Measurement of Initial Adhesion in Laminate 1

A laminate 1 was cut out into pieces of 15 mm in width. Using a tensile strength testing machine (TENSILON RTM-250 (trade name) manufactured by ORIENTEC Co., Ltd.), a 180° peel test was carried out under a room temperature environment at a peeling speed of 100 mm/min, and then initial adhesion of the adhesive was evaluated. The evaluation criteria were as shown below.

A: Peel strength was 10 (N/15 mm) or more, or material fracture occurred.

B: Peel strength was 6 (N/15 mm) or more but less than 10 (N/15 mm).

C: Peel strength was less than 6 (N/15 mm).

The “material fracture” as used herein means that the base material “polyolefin” or “PET” was fractured. Therefore, it means the strength of the adhesive per se was higher. 3. Evaluation of Hydrolysis Resistance in Laminate 1

A laminate 1 was put in a thermo-hygrostat and maintained in a wet heat state in an atmosphere at 85° C. and 85% RH for 3,000 hours. Then, a peel test similar to the measurement of initial adhesion in the laminate 1 was performed and the hydrolysis resistance of the adhesive was evaluated.

A: Peel strength was 10 (N/15 mm) or more, or material fracture occurred.

B: Peel strength was 6 (N/15 mm) or more but less than 10 (N/15 mm).

C: Peel strength was less than 6 (N/15 mm).

### 4. Measurement of Initial Adhesion in Laminate 2

A laminate 2 was cut out into pieces of 15 mm in width. Using a tensile strength testing machine (TENSILON RTM-250 (trade name) manufactured by ORIENTEC Co., Ltd.), a T-type peel test was carried out under a room temperature environment at a peeling speed of 300 ram/min, in accordance with an ASTM D1876-61 test. The evaluation criteria were as shown below.

A: Peel strength was 5 (N/15 mm) or more, or material fracture occurred.

B: Peel strength was 3 (N/15 mm) or more but less than 5 (N/15 mm) (no material fracture occurred).

C: Peel strength was less than 3 (N/15 mm) (no material fracture occurred).

### 5. Evaluation of Hydrolysis Resistance in Laminate 2

A laminate 2 was put in a thermo-hygrostat and maintained in a wet heat state in an atmosphere at 85° C. and 85% RH for 3,000 hours. Then, a peel test similar to the measurement of initial adhesion in the laminate 2 was performed and the hydrolysis resistance of the adhesive was evaluated.

A: Peel strength was 5 (N/15 mm) or more, or material fracture occurred.

B: Peel strength was 3 (N/15 mm) or more but less than 5 (N/15 mm) (no material fracture occurred).

C: Peel strength was less than 3 (N/15 mm) (no material fracture occurred).

### 6. Evaluation of Weatherability

A film for evaluation of weatherability was set to a UV irradiation tester (EYE Super UV Tester W131 (trade name) manufactured by IWASAKI ELECTRIC CO., LTD.) and then irradiation was carried out under the conditions of an illuminance of 1,000 W/m² at 60° C. and 50% RH for 100 hours. Using a color difference meter, a color difference (Δb) before and after irradiation was measured and the weatherability of the adhesive was evaluated based on the degree of yellowness (or color difference). The evaluation criteria were as shown below.

A: Δb was less than 5.

B: Δb was from 5 to 10.

C: Δb was more than 10.

TABLE 2

| | | Examples | | | | | | | | |
|---|---|---|---|---|---|---|---|---|---|---|
| | | 1 | 2 | 3 | 4 | 5 | 6 | 7 | 8 | 9 |
| (A) Acrylic polyol | A1 | 93.1 | | | | | | | | |
| | A2 | | 93.1 | | | | | 93.1 | 93.1 | 91.8 |
| | A3 | | | 92.7 | | | | | | |
| | A4 | | | | 86.0 | | | | | |
| | A5 | | | | | 80.0 | | | | |
| | A6 | | | | | | 95.0 | | | |
| | A′7 | | | | | | | | | |
| | A′8 | | | | | | | | | |
| (B) Silane | B1 | 2.8 | 2.8 | 2.8 | 2.6 | 2.4 | 2.9 | | | 2.8 |
| compound | B2 | | | | | | | 2.8 | | |
| | B3 | | | | | | | | 2.8 | |
| | B′4 | | | | | | | | | |
| | B′5 | | | | | | | | | |
| | B′6 | | | | | | | | | |
| (C) Isocyanate | C1 | 2.8 | 2.8 | 3.1 | 7.7 | 11.8 | 1.4 | 2.8 | 2.8 | 5.1 |
| compound | C2 | 1.3 | 1.3 | 1.5 | 3.7 | 5.8 | 0.7 | 1.3 | 1.3 | |
| | C3 | | | | | | | | | |
| | C′4 | | | | | | | | | |
| | C′5 | | | | | | | | | |
| Equivalent ratio | | 2.0 | 2.0 | 2.0 | 2.0 | 2.0 | 2.0 | 2.0 | 2.0 | 2.0 |
| NCO/OH | | | | | | | | | | |

| | | | | | | | | | |
|---|---|---|---|---|---|---|---|---|---|
| Appearance after PCT | A | A | A | A | A | A | A | A | A |
| test | | | | | | | | | |
| Laminate 1 | | | | | | | | | |
| Initial adhesion | A | A | A | B | B | A | A | A | B |
| Hydrolysis resistance | A | A | A | B | B | A | A | A | B |
| Laminate 2 | | | | | | | | | |
| Initial adhesion | A | A | B | B | B | A | A | A | A |
| Hydrolysis resistance | A | A | B | B | B | A | A | A | B |
| Weatherability | A | A | A | A | A | A | A | A | A |
| (UV decoloration | | | | | | | | | |
| resistance) | | | | | | | | | |

TABLE 3

| | | Examples | | | | | | | | |
|---|---|---|---|---|---|---|---|---|---|---|
| | | 10 | 11 | 12 | 13 | 14 | 15 | 16 | 17 | 18 |
| (A) Acrylic polyol | A1 | | | | | | | | | |
| | A2 | 91.2 | 89.6 | 93.1 | 92.0 | 95.0 | 92.0 | 95.6 | 95.4 | 90.5 |
| | A3 | | | | | | | | | |
| | A4 | | | | | | | | | |
| | A5 | | | | | | | | | |
| | A6 | | | | | | | | | |
| | A′7 | | | | | | | | | |
| | A′8 | | | | | | | | | |
| (B) Silane compound | B1 | 2.7 | 2.7 | 2.8 | 2.7 | 2.9 | 2.7 | 0.2 | 2.9 | 2.7 |
| | B2 | | | | | | | | | |
| | B3 | | | | | | | | | |
| | B′4 | | | | | | | | | |
| | B′5 | | | | | | | | | |
| | B′6 | | | | | | | | | |
| (C) Isocyanate | C1 | | 2.7 | 1.4 | 5.4 | 1.4 | 4.0 | 2.9 | 1.1 | 4.5 |
| compound | C2 | | | 2.7 | 0.6 | 0.7 | 2.0 | 1.3 | .6 | 2.3 |
| | C3 | 6.6 | 5.0 | | | | | | | |
| | C′4 | | | | | | | | | |
| | C′5 | | | | | | | | | |
| Equivalent ratio | | 1.2 | 2.0 | 2.5 | 2.5 | 1.0 | 3.0 | 2.0 | 0.8 | 3.4 |
| NCO/OH | | | | | | | | | | |
| Appearance after PCT | | A | A | A | A | A | A | A | A | A |
| test | | | | | | | | | | |
| Laminate 1 | | | | | | | | | | |
| Initial adhesion | | B | A | A | A | A | A | A | A | B |
| Hydrolysis resistance | | B | A | B | B | B | B | A | B | B |
| Laminate 2 | | | | | | | | | | |
| Initial adhesion | | B | A | A | A | A | A | B | A | A |
| Hydrolysis resistance | | B | A | A | A | B | B | B | B | B |
| Weatherability | | B | A | B | A | A | B | A | A | B |
| (UV decoloration | | | | | | | | | | |
| resistance) | | | | | | | | | | |

TABLE 4

| | | Comparative Examples | | | | | | | |
|---|---|---|---|---|---|---|---|---|---|
| | | 1 | 2 | 3 | 4 | 5 | 6 | 7 | 8 |
| (A) Acrylic polyol | A1 | | | | | | | | |
| | A2 | 95.7 | 93.1 | 93.1 | 93.1 | 95.5 | 94.0 | | |
| | A3 | | | | | | | | |
| | A4 | | | | | | | | |
| | A5 | | | | | | | | |
| | A6 | | | | | | | | |
| | A′7 | | | | | | | 93.1 | |
| | A′8 | | | | | | | | 93.1 |
| (B) Silane compound | B1 | | | | | 2.7 | 2.7 | 2.8 | 3.0 |
| | B2 | | | | | | | | |
| | B3 | | | | | | | | |
| | B′4 | | 2.8 | | | | | | |
| | B′5 | | | 2.8 | | | | | |
| | B′6 | | | | 3.0 | | | | |
| (C) Isocyanate | C1 | 2.9 | 2.8 | 2.8 | 2.8 | | | 2.8 | 2.8 |
| compound | C2 | 1.3 | 1.3 | 1.3 | 1.3 | | | 1.3 | 1.3 |
| | C3 | | | | | | | | |
| | C′4 | | | | | 1.8 | | | |
| | C′5 | | | | | | 3.3 | | |
| Equivalent ratio | | 2.0 | 2.0 | 2.0 | 2.0 | 2.0 | 1.0 | 2.0 | — |
| NCO/OH | | | | | | | | | |
| Appearance after PCT | | A | A | A | A | A | A | C | C |
| test | | | | | | | | | |
| Laminate 1 | | | | | | | | | |
| Initial adhesion | | A | B | A | A | B | B | B | C |
| Hydrolysis resistance | | A | C | A | A | C | C | C | C |
| Laminate 2 | | | | | | | | | |
| Initial adhesion | | C | B | B | B | C | | C | C |
| Hydrolysis resistance | | C | B | C | C | C | C | C | C |
| Weatherability | | A | A | A | A | C | C | B | C |
| (UV decoloration | | | | | | | | | |
| resistance) | | | | | | | | | |

As shown in Tables 2 to 4, the adhesives for laminated sheets of Examples 1 to 18 had a moderate curing rate and were excellent in initial adhesion to a film, hydrolysis resistance and weatherability. The adhesives for laminated sheets of the Examples underwent neither deterioration of adhesion nor yellowing, even though exposed to a severe environment. Therefore, the adhesives for laminated sheets of the present invention could sufficiently fulfill a role as an adhesive for solar battery back sheets for which high-level durability was required.

In contrast, the adhesives of Comparative Examples 1 to 8 were inferior to the adhesives for laminated sheets of the Examples in any one of a curing rate, initial adhesion to a film, hydrolysis resistance, and weatherability.

Since the adhesive of Comparative Example 1 contained no silane compound, wettability to a surface of the base material deteriorated, and thus the adhesive in the laminate 2 (PVDF/PET) was inferior in initial adhesion and hydrolysis resistance.

The adhesive of Comparative Example 2 underwent deterioration of adhesion since a silane compound added had an epoxy group but was not a glycidyl based silane compound; this lead to deterioration of hydrolysis resistance in the laminate 1 (PE/PET).

The adhesives of Comparative Examples 3 and 4 were inferior in adhesion to a surface of a PVDF base material since a silane compound added was not a glycidyl based silane compound; this lead to deterioration of hydrolysis resistance in the laminate 2.

The adhesives of Comparative Examples 5 and 6 underwent deterioration of photodiscoloration resistance against UV (ultraviolet rays) since they contained neither HDI nor XDI, but contained MDI or TDI. Initial adhesion and hydrolysis resistance to the laminate 2 also deteriorated.

In the adhesive of Comparative Example 7, the acrylic polyol (A′7) contained no acrylonitrile. The cohesive force of the adhesive per se decreased, and thus the adhesive was inferior in appearance after PCT test, in adhesion, and in hydrolysis resistance in the laminate 2 (PVDF/PET).

Since the acrylic polyol (A′8) had no hydroxyl group, no urethane bond was formed and the composition of Comparative Example 8 did not function as an adhesive.

### INDUSTRIAL APPLICABILITY

The present invention provides an adhesive for laminated sheets. The adhesive for laminated sheets according to the present invention is suited for use as an adhesive for solar battery back sheets since it is excellent in initial adhesion to a film and in curing rate; it is also excellent in long-term hydrolysis resistance at high temperature, resulting in remarkably enhanced durability against a severe environment, and in weatherability.

### DESCRIPTION OF REFERENCE NUMERALS

1: Solar battery module, 10: Back sheet, 11: Film, 11a: Deposited thin film, 12: Film, 13: Adhesive layer, 20: Sealing material (EVA), 30: Solar battery cell, 40: Glass plate, 50: Spacer

What is claimed is:

1. An adhesive for laminated sheets, comprising:
a urethane resin obtainable by mixing an acrylic polyol with an isocyanate compound; and
a silane compound; wherein
the silane compound contains a glycidyl based silane compound,
the acrylic polyol is obtainable by polymerizing a polymerizable monomer,
the polymerizable monomer contains a monomer having a hydroxyl group and the other monomer,
the other monomer contains acrylonitrile, and
the isocyanate compound contains at least one selected from xylylene diisocyanate and hexamethylene diisocyanate.

2. The adhesive for laminated sheets according to claim 1, wherein an equivalent ratio (NCO/OH) of an isocyanate group derived from xylylene diisocyanate and hexamethylene diisocyanate to a hydroxyl group derived from the acrylic polyol (A) is from 1.0 to 3.0.

3. The adhesive for laminated sheets according to claim 1, wherein the xylylene diisocyanate is a monomer and the hexamethylene diisocyanate is an isocyanurate form.

4. A raw material comprising an acrylic polyol for producing the adhesive for laminated sheets according to claim 1, wherein
the acrylic polyol is obtainable by polymerizing a polymerizable monomer,
the polymerizable monomer contains a monomer having a hydroxyl group and the other monomer, and
the other monomer contains acrylonitrile.

5. An adhesive for laminated film, comprising:
a urethane resin comprising the reaction product of an acrylic polyol and an isocyanate compound; and
a silane compound containing a glycidyl based silane compound; wherein
the acrylic polyol is obtainable by polymerizing a polymerizable monomer, the polymerizable monomer comprising a first monomer having a hydroxyl group and a second different monomer containing acrylonitrile, and
the isocyanate compound contains at least one isocyanate selected from xylylene diisocyanate and hexamethylene diisocyanate.
